(19) United States
(12) Patent Application Publication
(10) Pub. No.: US 2005/0244546 A1
(43) Pub. Date: Nov. 3, 2005

(54) Method for extending the shelf life of perishable agricultural products and/or food

(75) Inventor: Hanspeter Steffen, Utzenstorf (CH)

Correspondence Address: BIRCH STEWART KOLASCH & BIRCH, PO BOX 747, FALLS CHURCH, VA, 22040-0747, US

(73) Assignee: Hispano Suiza De Patentes S.L., Bodilla Del Monte (ES)

(21) Appl. No.: 10/525,013

(22) PCT Filed: Aug. 16, 2003
(86) PCT No.: PCT/CH03/00561

§ 371 Date: Feb. 17, 2005

(30) Foreign Application Priority Data
Aug. 19, 2002 (CH) 142/02

(51) Int. Cl. C12C 1/027

(52) U.S. Cl. 426/106

(57) ABSTRACT

In order to extend the shelf life of perishable agricultural products and/or food, said agricultural products and/or food items are placed in a packaging container (10), a modified atmosphere is created in the packaging container (10), and the packaging container (10) is closed. The modified atmosphere is created in such a way that it has an increased concentration in oxygen compared to normal ambient air. Conclusively the invention provides for a method and a packaging which extend the shelf life of delicate agricultural products and/or food.

### TECHNICAL FIELD

The Invention concerns a method for extending the shelf life of perishable agricultural products and/or food and a packaging for the implementation of the method according the precharacterising part of the independent claims.

### STATUS OF TECHNOLOGY

For packaging and/or storing perishable agricultural products and/or food like fruits, vegetable, cut flowers, cheese and a like different methods and apparatus are known, which may extend the naturally limited shelf life of such agricultural products or food. As quite successful has been proven the use of the MAP-technology (modified atmosphere packaging) developed in the last few years, whereby the agricultural products or food are kept in a packaging which contains an atmosphere which in comparison to the atmosphere of normal ambient air is modified.

In the publication EP-A2-1 106 084 (Comi) a method for packaging food is described, where food products are kept within the packaging in an alcohol containing atmosphere.

The publication WO-A1-01/89310 (Steffen) concerns a packaging system for the conservation of fresh agricultural products and/or food. The agricultural or food products are first filled in a polypropylene tray with anti-fog coating. Afterwards the air is evacuated from the tray and replaced by a gas mixture of 75% nitrogen and 25% carbon dioxide and afterwards the tray is hermetically sealed with a plastic film. In the plastic film an overpressure valve is integrated, which is made out of hard polypropylene and/or polyethylene. The gases created by the metabolic remaining respiration of the agricultural or food products can escape through the overpressure valve from the tray which otherwise is hermetically sealed.

In case of very delicate agriculture and/or food products the shelf life of these products is still not satisfactory, even when using known MAP methods and packaging.

### PRESENTATION OF INVENTION

The object of the invention is the presentation of a method which enables an extension of the shelf life of perishable agricultural products and/or food in a packaging, as well as a packaging for the implementation of the method.

The solution of this object is defined by the features of the independent claims. According to the invention, a method for extending the shelf life of perishable agricultural products and/or food like fruits, vegetable, cut flowers, cheese, meat and the like contains the steps of introducing the agricultural products or food in a packaging container, establishing a modified atmosphere in the packaging container and sealing the packaging container. Hereby the modified atmosphere is created in such a way that it contains an increased oxygen concentration when compared to normal ambient air.

This means, that the inventive method contains a step of at least temporarily (i.e. for a period of several minutes) creating within the packaging container (i.e. in the inner space enclosed by the packaging container) a modified atmosphere with an increased oxygen concentration. Without any other indication the meaning of oxygen concentration in the context of the present description and the claims relates always to the concentration of molecular oxygen (i.e. the concentration of O₂—gas). The increased oxygen concentration can be created with by means of known methods and techniques for the MAP-technology, for instance by firstly evacuating from the packaging container the non modified atmosphere, which corresponds to the atmosphere of ambient air, and then re-injecting into the packaging container a gas mixture which corresponds to the desired modified atmosphere. In principle other methods for creating a modified atmosphere are also possible.

The high concentration of oxygen retards the development of anaerobic and aerobic germs in the packaged products, i.e. in the agricultural and food products contained in the packaging container. Additionally—in case of agricultural products containing cut surfaces due to the harvest procedure—the high oxygen content retards the browning of the cut surfaces of the agricultural products contained in the packaging container.

According to a preferred embodiment of the invention the modified atmosphere is created such, that the oxygen concentration in the modified atmosphere is between 40% and 90%, preferably between 60% and 85%, especially approximately 80% in relation to the total modified atmosphere. These ranges of concentration have been proven to be effective regarding the amelioration of the shelf life of various different vegetables and fruits.

Without any other explanations the gas concentration indicated in percent do always mean volumetric percentages in connection with the present description and the claims.

Advantageously the modified atmosphere is created in such a way that it additionally contains an increased concentration of carbon dioxide (CO₂—gas), compared to normal ambient air, where as the concentration of carbon dioxide is preferably between 2% and 25%, especially approximately 10% of the total volume of the modified atmosphere. The high concentration of carbon dioxide serves primarily for retarding metabolic processes, especially the remaining respiration of the products in the packaging container. Moreover the high carbon dioxide concentration reduces the pH-value, which is retarding the microbial multiplication. The high carbon dioxide concentration can be achieved by injecting external carbon dioxide gas into the packaging container. As an alternative and/or in combination with that the high content of carbon dioxide can also be built up by the metabolic remaining respiration of the packaged products.

The modified atmosphere can furthermore be established in such a way that it contains an elevated concentration of ozone in comparison to normal ambient air. Hereby the relevant ozone concentration (i.e. the concentration of O₃—gas) may be between 1% and 17%, preferably between 5% and 16%, especially between 10% and 15% in relation to the oxygen concentration in the modified atmosphere. These ranges of ozone concentration have been proven correct in connection with the inventive method for a large number of different agricultural and/or food products. The ozone guarantees sterilization respectively a disinfection of the packaged products, in eliminating microbes like fungus, yeast, bacteria, virus etc. In contrast to the known disinfection processes by heating the packaged goods or by using chloral gas or propylene oxide, the packaged goods does not suffer from any product alteration whatsoever by ozone sterilisation. In addition, there are no residues left in the packaging container, because ozone transforms itself in a few hours in molecular oxygen.

Preferably the modified atmosphere is created in such a way, that in addition that it contains an elevated concentration of an inert gas in comparison to normal ambient air, preferably a noble gas, whereby the inert gas concentration is between 2% and 10%, especially 8% (in relation to the total modified atmosphere). Argon has been proven to be especially suitable for the use as an inert gas for the method according to this version of the invention.

According a further preferred embodiment of the inventive method the packaging container—after having been sealed—is irradiated by ultraviolet light. On one hand numerous microbes are directly destroyed through the UV-light, thus contributing to an extension of shelf life of the packaged goods. On the other hand the ultraviolet light is creating additional ozone in the closed packaging container because of the high internal oxygen content. This ozone, as described above, acts as a sterilization medium for the packaged goods, thus again contributing to the extension of shelf life of the packaged goods.

The packaging container, for instance, may be irradiated during more than two minutes by ultraviolet light, which has an intensity between 0.1 and 2.0 W/m². Preferably the packaging container is irradiated by ultraviolet light such, that the density of energy (i.e. the energy per unit surface) of the ultraviolet light impinging on the packaging container is between 2,000 mW sec cm⁻² (20 kJ m⁻²) and 10,000 mW sec cm⁻² (100 kJ m⁻²). Hereby the wave length of the ultraviolet light may be between 180 nm and 280 nm. Preferably the ultraviolet light has a (spectral) intensity maximum at a wavelength of about 185 nm. At this wavelength the production of ozone by the ultraviolet light is at a maximum. Moreover, in combination or as an alternative to a intensity maximum at a wavelength of about 185 nm, advantageously the ultraviolet light has another (spectral) intensity maximum at a wavelength of about 254 nm. At a wavelength of about 254 nm the bactericidal effect of the ultraviolet light is ideal. By using the indicated intensities and wave lengths, in the packaging container a ozone concentration will be created in such a way that the shelf life of agricultural products and food in the container will be significantly extended.

According to a further aspect of the invention, the agricultural or food products are washed with ozonic water prior to bringing them into the container. Washing with ozonic water induces, on the one hand, a sterilization and disinfection of the agricultural or food products, by eliminating microbes like fungus, yeast, bacteria, virus etc. On the other hand, washing with ozonic water brings additional into the packaging container, when the agricultural or food products are filled into the packaging container together with residual washing water. It is obvious, that this aspect of the invention must not be used compulsory in connection with increasing the oxygen concentration in the packaging container.

The ideal ozone concentration in the washing water to improve the shelf life of the washed agricultural or food products has been proven to be between 2 mg/l and 20 mg/l, preferably between 4 mg/l and 10 mg/l, especially between 6 mg/l and 8 mg/l.

A packaging container together with the included perishable agricultural products or food manufactured according the inventive method is characterized by the features, that the sealed packaging container contains the agricultural or food products and a modified atmosphere, the modified atmosphere having an increased concentration of oxygen, relative to normal ambient air. By that a long shelf life of the agricultural products or food contained in the packaging container is achieved.

According to a further aspect of the invention, the packaging comprises a packaging container, which is suitably constructed for containing perishable agricultural products and/or food and for creating a modified atmosphere within the packaging space defined by the container, the container being essentially hermetically sealable and further comprising a gas passage device for the release of gases from the packaging space, said gases being produced by metabolic residual respiration of the agricultural or products contained in the packaging container. The gas passage device is built as a flat, preferably flexible foil structure, which forms at least a section of the wall of the packaging container. In the present context, an essentially hermetically sealable packaging container means a packaging container, which—except for the passage of gases passing through the gas passage device—is sealable in a usual manner for MAP-technology.

The formation of the gas passage device as a flat foil structure permits a simple and cost efficient production of the device in the course of the foil manufacturing process. In contrast to this production technique, the gas passage devices used up to date in MAP technology, such as for instance the type described in the publication WO 01/89310 (Steffen) consisting of a overpressure one-way valve made out of hard plastic, were complicated to manufacture and therefore expensive.

The described packaging for perishable food proves to be advantageous, even independently from an increased concentration of oxygen in the packaging container and independently of the washing of the packaging goods with ozonic water. The packaging container is typically formed in such a way that it can hold agricultural products and/or food with a net mass between 0.1 and 10 kg.

The gas passage device made in form of a flat foil structure may comprise a semi-permeable plastic foil, which is manufactured in such a way, that on it's entire surface the gas permeability for molecular oxygen is between 1,000 cm³ m⁻² day⁻¹ (1.16*10⁻⁸ m sec⁻¹) and 10,000 cm³ m⁻² day⁻¹ (1.16*10⁻⁷ m sec⁻¹), preferably between 3,000 cm³ m⁻² day⁻¹ (3.5*10⁻⁸ m sec⁻¹) and 6,400 cm³ m⁻² day⁻¹ (7.4*10⁻⁸ m sec⁻¹), and for carbon dioxide the gas permeability is between 3,000 cm³ m⁻² day⁻¹ (3.5*10⁻⁸ m sec⁻¹) and 30,000 cm³ m² day⁻¹ (3.5*10⁻⁷ m sec⁻¹), preferably between 12,000 cm³ m² day⁻¹ (1.39*10⁻⁷ m sec⁻¹) and 16,000 cm³ m⁻² day⁻¹ (1.86*10⁻⁷ m sec⁻¹). Especially for relative small packagings, designed for holding packaging goods up to a total mass of approximately 2 kg, gas passage devices consisting merely of such foil structures are often sufficient to achieve the desired shelf life of products.

As an alternative and/or supplement to a semi-permeable plastic foil the gas passage device formed by a flat foil structure may also comprise a foil made out of a minimum of two joined layers (foil layers) containing at least one pocket defining zone where the two foil layers are not joined, and where a pressure sensitive sealing material is inserted between the two foil layers. In the pocket zone perforations are made in the two foil layers in such a way, that they are permeable for gases, but essentially not permeable for the sealing material, thus creating a gas overpressure valve in the pocket zone. A pressure sensitive sealing material in the present context means a sealing material, which has the property to be gas tight for relatively small pressure differentials between spaces separated by the sealing material, whereas it is permeable for gas when the pressure differential is relatively large. The sealing material may be for instance of such kind, that the gas overpressure valve formed in the pocket zone of the foil is tight for pressure differentials below approximately 10 mbar (10 hPa), whereas it is permeable for pressure differentials above approximately 30 mbar (30 hPa). Depending on the kind of the packaging goods and/or the kind of the packaging container other pressure limits between the tight and the permeable status of the overpressure valve are possible.

The pressure sensitive sealing material may be a gel-like mass, especially a gel-like silicon oil (also designated as silicon fat or silicon paste). In principle however other suited pressure sensitive sealing materials may be used.

Preferably the perforations are made in both foil layers at mutually displaced locations, where the pressure sensitive sealing material is enclosed in between. Thus a good sealing capacity for small pressure differentials is achieved of the gas overpressure valve formed in the pocked area of the foil, because in this a case never a perforation in one of the layers is arranged directly above another perforation in the other layer. In principle however other arrangements of the perforations also are possible.

According to a further preferred variant of the invention, an anti-microbial substance is mixed into the gel-like material. With this feature is achieved, that in case of microbes entering through the overpressure valve formed in the pocket zone of the foil these microbes are essentially eliminated.

Another preferred embodiment of the invention is characterised in that an ethylene binding substance (i.e. an ethylene adsorbing and/or absorbing substance) is added to the gel-like material. Such a substance may be for instance titanium dioxide (TiO₂). The ethylene binding substance keeps away the ripening gas ethylene, which is unwanted in the packaging, from the packaged goods, and thus increases again the shelf life of the packaged goods.

Preferably at least one section of a wall of the packaging container is made in such a way, that in this section the wall of the packaging container is highly transparent to ultraviolet light. Such a packaging is very well adapted for use in connection with the different variants of the method according to the invention, which provide illumination of the packaging together with the packaged goods by ultraviolet light.

Preferably the packaging container is further made in such a way, that it is suitable for cooking the agricultural or food products contained in the sealed packaging container in a micro-wave oven. Such a packaging container may for instance comprise a tray, which is open on top and which is made out of heat resistant polypropylene, PET-C (polyethyleneterephthalate) or another suited heat resistant plastic material, and which is hermetically sealed by a transparent, flexible cover foil made out of polyester or another suitable plastic material, whereby the cover foil may be torn off from the tray in the manner of a peeling-off-closure, in order to open the packaging container and to consume the packaging goods.

Preferably in the microwaveable container is further arranged a hydrogel mass, which will release water when heated. Thus is provided that during the storage and the transport of the packaging goods at usual temperatures the water is bound by the hydrogel thus keeping the packaging goods contained in the sealed packaging container essentially dry. When the still sealed packaging container later is heated in a micro-wave oven, the water exits the hydrogel, then supporting the cooking process in the micro-wave oven in form of cooking water and/or water-steam.

According to a further preferred aspect of the invention a drying agent is additionally arranged in the packaging-container. The drying agent is binding liquid water which may eventually be present in the packaging container, said liquid water being produced for instance from condensation and/or metabolic residual respiration of the packaged goods. Altogether the drying agent provides for a dry storage of the agricultural or food products contained in the packaging container and thus provides for further extension of the shelf life of these goods.

The following detailed description and the claims show further embodiments and combinations of features of the invention.

### SHORT DESCRIPTION OF DRAWINGS

The figures used for explaining an embodiment of the invention show:

FIG. 1 a packaging container of a packaging according to a first preferred embodiment of the invention in a simplified perspective view;

FIG. 2 the cover foil of the packaging container from FIG. 1 in simplified view from top;

FIG. 3 the cover foil from FIG. 2 in a simplified, schematic partial view sectioned along line A-A.

In principal, identical parts are marked with identical reference numbers in the figures.

### WAYS FOR CARRYING OUT THE INVENTION

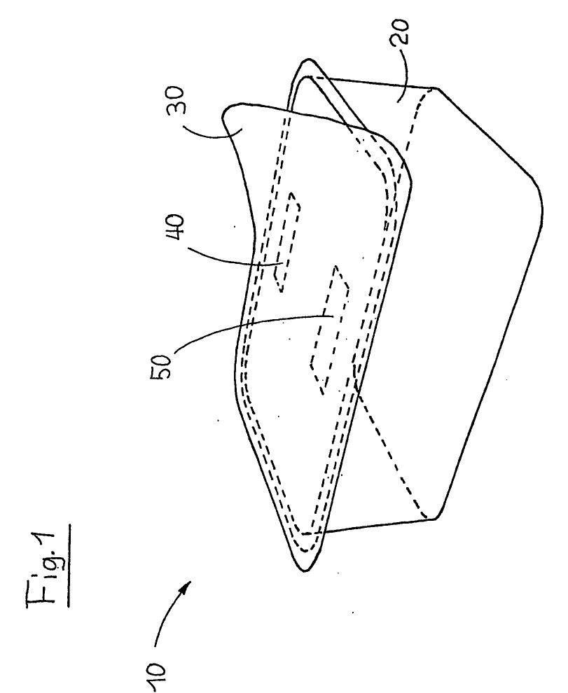

FIG. 1 shows a packaging container 10 of a packaging according to a preferred embodiment of the invention in a simplified perspective view. The packaging container 10 comprises a tray 20 with the upper part open, which is made out of heat resistant polypropylene. The packaging container 10 further comrises a transparent, flexible cover foil 30, with which the tray 20 is essentially hermetically sealable, by welding the cover foil 30 to the upper edge of the tray 20. For opening the packaging container 10, the cover foil 30 can be torn off from the tray 20 in the manner of a so called peeling seal (also designated as tear-off seal). In FIG. 1 the cover foil 30 is shown in a partly torn off state.

The cover foil 30 has essentially a two layer construction and contains a first foil layer 34 made from polyethylene (PE) and a second foil layer 32 made from polyester. In a closed estate of the packaging container 10, the foil layer 34 made of polyethylene is welded to the upper edge of the tray and builds the inner side of the cover foil 30, which inner side is facing the packaging space or the packaging goods (not depicted) contained in the tray, whereas the foil layer 32 made from polyester builds the outer side of the cover foil 30, which outer side faces away from the packaging goods.

The two foil layers 32, 34 are bonded and sandwiched together in a usual way of foil manufacturing, except for two rectangular areas 40, 50. In the areas where the two foil layers 32, 34 are bonded together the cover foil 30 forms a semi-permeable membrane with a gas permeability between 3,000 cm³ m⁻² day⁻¹ (3.5*10⁻⁸ m sec⁻¹) and 6,400 cm³ m⁻² day⁻¹ (7.4*10⁻⁸ m sec⁻¹) for molecular oxygen and a gas permeability for carbon dioxyde between 12,000 cm³ m⁻² day⁻¹ (1.39*10⁻⁷ m sec⁻¹) and 16,000 cm³ m⁻² day⁻¹ (1.86*10⁻⁷ m sec⁻¹).

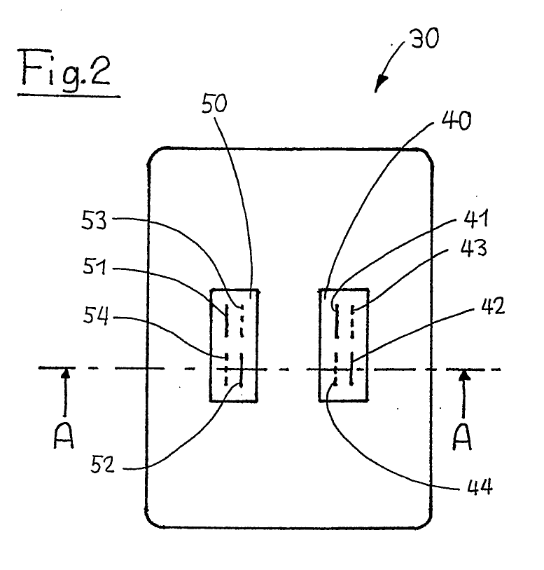

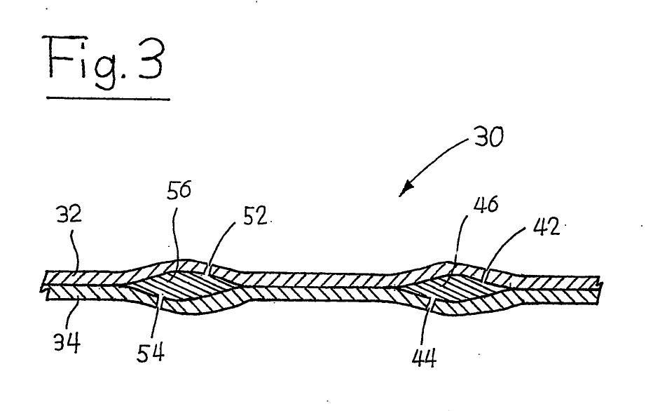

In the two rectangular areas 40, 50, the two foil layers 32, 34 are not bonded together, such that in each of these areas a pocket 40, 50 is created in between the two foil layers 32, 34. The pockets 40, 50 are each filled with a mass 46, 56 of gel-like silicon oil (also designated as silicon fat or silicon paste). Furthermore, in the area of the pockets 40, 50 there are perforations 41, 42, 43, 44, 51, 52, 53, 54 established in the foil layers 32, 34 in such a way, that they are permeable for gases, but essentially impermeable for the gel-like silicon oil 46,56. In the embodiment of the invention shown in FIGS. 1 to 3 each of these perforations 41, 42, 43, 44, 51, 52, 53, 54 consists of two small slits 43, 44, 53, 54 in the inner foil layer 34 and two small slits 41, 42, 51, 52 in the outer foil layer 32 for both pockets 40, 50, the slits 43, 44, 53, 54 in the inner foil layer 34 being offset relative to the slits 41, 42, 51, 52 in the outer foil layer 32, such that never a slit 41, 42, 51, 52 in the outer foil layer 32 is positioned directly above another slit 43, 44, 53, 54 of the inner foil layer 34.

The gel-like silicon oil 46, 56 in the two pockets 40, 50 is a pressure sensitive sealing agent for gas, because for small pressure differentials between the inner side and the outer side of the cover foil 30 it is gas tight, whereas for large pressure differentials it is gas permeable. Altogether each of the the two pockets 40, 50 filled with silicon oil 46, 56 is forming a gas overpressure valve, which is airtight for pressure differentials below approx. 10 mbar (10 hPa). For pressure differentials above approx. 30 mbar (30 hPa) the two gas overpressure valves made by the foil pockets 40, 50 are permeable for gases. Thus, when pressure differentials above approx. 30 mbar (30 hPa), gases may escape from the packaging space through the two foil pockets 40, 50, even when the packaging container 10 is sealed.

A substance with anti-bacterial properties is added to the silicon oil 46, 56 in the foil pockets 40, 50. With this feature is achieved, that in case of microbes entering through the overpressure valves formed in the pocket areas 40, 50 of the cover foil 30, these microbes are essentially eliminated.

Furthermore, titanium dioxide (TiO₂) is added to the silicon oil 46, 56 in the foil pockets 40, 50. The titanium dioxide has ethylene binding properties. It is binding eventual build ups of ethylene in the packaging space, produced by the packaging goods (not shown) in the packaging space, and keeps this unwanted ripening gas away from the packaging goods.

The cover foil 30 is basically transparent and thus permits visual control of the packaged goods through the cover foil 30. The cover foil 30 is also essentially transparent for ultraviolet light. Thus it is possible to illuminate the packaged goods by ultraviolet light through the cover foil 30.

Furthermore the cover foil 30 is coated on it's inner side facing the packaged goods with a condensation inhibitor medium (also called anti-fog coating), such that the clear sight transparency through the cover foil 30 is not hindered by accumulating condensation drops on the cover foil 30.

The packaging container 10 shown in FIGS. 1 to 3 is adapted for micro wave cooking. This means that for cooking the food products (not shown) contained in the packaging container 10 these food products may be put into a micro wave oven together with the closed packaging container 10 and then be cooked by micro waves. After the cooking, the cover foil 30 may be torn off from the tray 20, and then the food products may be eaten directly from the tray.

In order to support the cooking process, the sealed packaging container 10 contains in addition to the food products (not shown) forming the packaging goods still a hydrogel mass (not shown). During normal ambient temperatures, the water of the hydrogel mass remains bound in the hydrogel mass. As soon as the packaging together with the packaging goods is heated in the microwave oven, at least parts of the water of the hydrogel mass are set free by the heating. This water then supports in form of cooking water and/or water vapour the cooking process in the microwave oven.

The packaging container 10 shown in FIGS. 1 to 3 is suitable for storing of perishable agricultural products and/or food (not shown) in such a way, that they can be kept fresh for a long time. It is suitable especially for storing of fresh cut vegetables like prepared French beans, carrot sticks, appetizer sticks, peeled asparagus, broccoli and/or cauliflower rosettes, cut sugar peas, pepper slices, ratatouille, cut mushrooms, fresh peeled black roots, fruit salads and fruit chunks.

In order to achieve a long shelf life of asparagus by means of the packaging container (10) depicted in FIG. 1 to 3, asparagus (not shown) are first harvested, then peeled and washed during approximately three minutes in drinking water containing ozone (not shown), whereby the ozone content of the water is between 6 and 8 mg/l. The washing with ozonic drinking water establishes a first disinfection of the asparagus. Afterwards a desired quantity of asparagus having a net weight of approximately 500 g is filled in the open tray 20 of the packaging container 10, whereby prior to this a hydrogel mass (not shown) has been poured on the floor of the tray 20.

Thereafter, in an apparatus (not shown) essentially known for MAP-technique, first the non modified atmosphere corresponding to the atmosphere of ambient air, is evacuated from the tray 20, then a gas mixture corresponding to a modified atmosphere is re-injected into the tray 20, and afterwards the tray 20 is essentially hermetically sealed, by welding the cover foil 30 onto the upper edge of the tray 20. The gas mixture, which is re-injected into the tray 20, consists essentially of 70% molecular oxygen, 10% carbon dioxide, 12% ozone and 8% Argon. The high content of molecular oxygen and ozone in this modified atmosphere performs a second sterilization of the asparagus (not shown) contained the packaging container 10.

Next the asparagus inside the sealed packaging container 10 are irradiated through the cover foil 30 during approximately two minutes by ultraviolet light, whereby a light source arranged in a distance of approximately 2 cm from the packaging container transmits ultraviolet light, which when impinging onto the packaging container has an intensity of approximately 0.4 W/m² and has an intensity maximum at a wavelength of approximately 185 nm. The energy densitiy of the total ultraviolet light arriving at the packaging container is approximately 4,800 mW sec cm⁻² (48 kJ m⁻²). The illumination by ultraviolet light implements a further sterilization of the asparagus contained in the packaging container 10. The so treated asparagus have a shelf life inside the sealed packaging container 10 of approximately 3 weeks.

The ozone, which has been re-injected into the packaging container 10, and/or the ozone produced by the ultraviolet radiation inside the packaging container 10 disintegrate in a few hours again to molecular oxygen, which then diffuses through the cover foil 30 to the exterior and/or which is adsorbed by the asparagus in the course of their metabolic residual respiration. After approximately 24 hours a respiration balance establishes itself automatically, due to the cover foil 30, which is semi-permeable for molecular oxygen, and due to the overpressure valves built by the foil pockets 40, 50, through which carbon dioxide and water vapour created by the metabolic residual respiration of the asparagus may escape.

As a conclusion one can realize, that the invention indicates a method and a packaging, which allow an extension of shelf life of delicate agricultural products and/or food.

1. Method for extending the shelf life of perishable agricultural products and/or food, whereby the method includes the steps of filling the agricultural or food products into a packaging container (10), creating a modified atmosphere inside the packaging container (10) and sealing the packaging container (10), characterised in that the modified atmosphere is created in such a way, that it contains an increased concentration of oxygen compared to normal ambient air.

2. Method according claim 1, characterised by creating the modified atmosphere in such a way, that the concentration of oxygen in the modified atmosphere is between 40% and 90%, preferably between 60% and 85%, especially approximately 80%.

3. Method according to claim 1 or 2, characterised by creating the modified atmosphere in such a way, that it additionally contains an increased concentration of carbon dioxide compared to normal ambient air, whereby the carbon dioxide concentration is preferably between 2% and 25%, especially approximately 10%.

4. Method according to claim 1, characterised by creating the modified atmosphere in such a way, that it further contains an increased concentration of ozone compared to normal ambient air, whereby the ozone concentration is between 1% and 17%, preferentially between 5% and 16%, especially between 10% and 15% in relation to the oxygen concentration in the modified atmosphere.

5. Method according to claim 1, characterised by creating the modified atmosphere in such a way, that it further contains an elevated concentration of an inert gas, preferably a noble gas, compared to normal ambient air, whereby the concentration of the inert gas preferably is between 2% and 10%, especially approximately 8%.

6. Method according to claim 1, characterised in that after sealing of the packaging container (10) it is irradiated with ultraviolet light in such a way, that ozone is created by the ultraviolet light due to the high concentration of oxygen inside the sealed packaging container (10).

7. Method according to claim 6, characterised in that the packaging container (10) is irradiated with ultraviolet light such, that the density of energy of the ultraviolet light impinging on the packaging container is between 2,000 mW sec cm⁻² (20 kJ m⁻²) and 10,000 mW sec cm⁻² (100 kJ m⁻²), whereby the ultraviolet light has a wavelength between approximately 160 nm and approximately 280 nm and preferably a intensity maximum at 185 nm and/or a intensity maximum at 254 nm.

8. Method for extending the shelf life of perishable agricultural products and/or food in a packaging container in particular according to claim 1, characterised in that prior to be filled into the packaging container the agricultural or food products are washed with ozonic water.

9. Method according to claim 8, characterised in that the washing water has a ozone content between 2 and 20 mg/l, preferentially an ozone content between 4 and 10 mg/l, especially an ozone content between 6 and 8 mg/l.

10. Packaging container (10) with perishable agricultural products and/or food contained in the container, manufactured according to the method according claim 1, whereby the agricultural or food products and a modified atmosphere are contained inside the sealed packaging container (10), characterised in that the modified atmosphere contains an increased concentration of oxygen compared to normal ambient air.

11. Packaging especially for the implementation of the method according to claim 1, including a packaging container (10) made in such a way that it may contain perishable agricultural products and/or food and that a modified atmosphere may be created within the packaging space defined by the packaging container (10), the packaging container (10) being essentially hermetically sealable and being equipped with a gas passage device (30, 40, 50) for the release of gases out of the packaging space, said gases being produced by the metabolic residual respiration of the agricultural or food products contained in the packaging container (10), characterised in that the gas passage device (30, 40, 50) is constructed as a flat foil structure, which forms at least one section of the wall of the packaging container (10).

12. Packaging according claim 11, characterised in that the gas passage device (30, 40, 50) comprises a semi-permeable plastic foil (30), which is constructed in such a way, that on it's entire surface the gas permeability for molecular oxygen is between 1,000 cm³ m⁻² day⁻¹ (1.16*10⁻⁸ m sec⁻¹) and 10,000 cm³ m⁻² day⁻¹ (1.16*10⁻⁷ m sec⁻¹), preferably between 3,000 cm³ m⁻² day⁻¹ (3.5*10 ⁻⁸ m sec⁻¹) and 6,400 cm³ m⁻² day⁻¹ (7.4*10⁻⁸ m sec⁻¹), and for carbon dioxide the gas permeability is between 3,000 cm³ m⁻² day⁻¹ (3.5*10⁻⁸ m sec⁻¹) and 30,000 cm³ m⁻² day⁻¹ (3.5*10⁻⁷ m sec⁻¹), preferably between 12,000 cm³ m⁻² day⁻¹ (1.39*10⁻⁷ m sec⁻¹) and 16,000 cm³ m⁻² day⁻¹ (1.86*10⁻⁷ m sec⁻¹).

13. Packaging according claim 11 or 12, characterised in that the gas passage device (30, 40, 50) comprises a foil (30) made out of a minimum of two joined layers (32, 34) containing at least one pocket defining zone (40, 50) where the two foil layers (32, 34) are not joined and where a pressure sensitive sealing material (46, 56) is inserted between the two foil layers (32, 34), whereby in the pocket zone (40, 50) perforations (41, 42, 43, 44, 51, 52, 53, 54) are built in the two foil layers (32, 34) in such a way, that they are permeable for gases, but essentially not permeable for the sealing material (46, 56), thus creating a gas overpressure valve in the pocket zone (40, 50).

14. Packaging according to claim 13, characterised in that the pressure sensitive sealing material (46, 56) is a gel-like mass (46, 56).

15. Packaging according to claim 14, characterised in that the perforations (41, 42, 43, 44, 51, 52, 53, 54) are arranged at mutually displaced locations in both foil layers (32, 34).

16. Packaging according claim 14, characterised in that an anti-microbial substance is added and mixed to the gel-like mass (46, 56).

17. Packaging according claim 14, characterised in that an ethylene binding substance is added and mixed to the gel-like mass (46,56).

18. Packaging according to claim 11, characterised in that at least one section of the wall of the packaging container (10) is made in such a way, that this section the wall of the packaging container wall is highly transparent for ultraviolet light.

19. Packaging according to claim 11, characterised in that the packaging container (10) is made in such a way, that it is suitable for cooking the agricultural or food products contained in the sealed packaging container (10) in a micro-wave oven.

20. Packaging according to claim 19, characterised in that it further comprises a hydrogel mass arranged in the packaging container (10), said hydrogel mass releasing water when heated.

21. Packaging according to claim 11, characterised in that it further comprises a drying agent arranged in the packaging container (10).
